(19) United States
(12) Patent Application Publication
(10) Pub. No.: US 2010/0266789 A1
(43) Pub. Date: Oct. 21, 2010

(54) METAL CORD REINFORCED FLEXIBLE PIPE

(75) Inventors: JEFFREY RYAN CONLEY, Calgary (CA); SAMUEL GLEN BOUEY, Calgary (CA); ERIC JAMES SLINGERLAND, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignee: FLEXPIPE SYSTEMS INC., Calgary (CA)

(21) Appl. No.: 12/763,506

(22) Filed: Apr. 20, 2010

Related U.S. Application Data
(60) Provisional application No. 61/170,798, filed on Apr. 20, 2009.

(51) Int. Cl. B32B 1/08; B65H 81/00; B32B 37/02; B29C 63/10

(52) U.S. Cl. 428/34.1; 156/188

(57) ABSTRACT

A flexible pipe for conveying pressurized fluids that has an inner tubular layer, two reinforcing layers, an outer layer and a barrier layer. The reinforcing layers are comprised of metal cords wrapped around the inner tubular layer. The metal cords may be comprised of multiple individual wires twisted about themselves or a central guide line. The barrier layer may be positioned between the two reinforcing layers and penetrate therebetween. Additionally, a method for making a flexible pipe is provided, which includes the use of heat to facilitate the penetration of the barrier layer into each of the reinforcing layers.

### CROSS REFERENCE TO RELATED APPLICATIONS

The present application claims priority under 35 U.S.C. §119(e) to U.S. provisional patent application No. 61/170,798 filed Apr. 20, 2010.

### FIELD OF THE INVENTION

The present invention relates to flexible reinforced pipes and more particularly to a flexible pipe reinforced with metal cord.

### BACKGROUND OF THE INVENTION

Flexible pipes are needed for conveying fluids under pressure such as sour gas, carbon dioxide, hydrocarbons, etc. These flexible pipes need to meet certain performance requirements, such as having sufficient strength to contain the high pressure fluid the pipe may be transporting. These performance requirements have to be met in a number of different situations including when the pipe is buried, unrestrained or bent, yet still be sufficiently flexible to allow the pipe to be spooled for transport without collapsing or buckling, even in low temperature environments, and to be maneuvered and installed in various applications.

### SUMMARY OF THE INVENTION

In accordance with a broad aspect of the present invention there is provided a flexible pipe comprising: an inner tubular layer with an inner surface and an outer surface, the inner surface forming a central bore for conveying a fluid therewithin; a first reinforcing layer of at least one first metal cord wound around the outer surface in a first helical direction to support axial and radial loads on the inner tubular layer, the first reinforcing layer including valleys defined between adjacent wraps of the at least one first metal cord; a second reinforcing layer of at least one second metal cord wound outwardly of the first reinforcing layer to support axial and radial loads on the inner tubular layer and the first reinforcing layer, the second reinforcing layer including valleys defined between adjacent wraps of the at least one second metal cord; an outer layer provided on the second reinforcing layer to protect the first and second reinforcing layers; and a barrier layer between the first and second reinforcing layers, the barrier layer penetrating into the valleys of the first and second reinforcing layers.

In accordance with another broad aspect of the present invention there is provided a method for making pipe, the method comprising: tensively wrapping at least one first metal cord in a first direction around an inner tubular member at a first angle, the at least one first metal cord forming a first reinforcing layer and having valleys defined between adjacent wraps of the at least one first metal cord; forming a barrier layer over the first reinforcing layer, the barrier layer penetrating into the valleys of the first reinforcing layer; tensively wrapping at least one second metal cord in a second direction around an inner tubular member at a second angle, the at least one second metal cord forming a second reinforcing layer and having valleys defined between adjacent wraps of the at least one second metal cord, the barrier layer penetrating into the valleys of the second reinforcing layer; and applying an outer layer over the second reinforcing layer.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a side view of a pipe in a first aspect, partially cut away, in successive layers;

FIG. 2 is an end sectional view of the pipe along line AA′ in FIG. 1;

FIG. 3 is a top view of a metal cord with a Z lay direction;

FIG. 4 is a top view of a metal cord with an S lay direction;

FIG. 5 is a schematic illustration of a metal cord in a further aspect;

FIG. 6 is a schematic illustration of a metal cord in a further aspect, having a lay direction opposite to metal cord shown in FIG. 5;

FIG. 7 is a schematic illustration of a metal cord having a lang's lay configuration;

FIG. 8 is a side view of a pipe in a further aspect, partially cut away, in successive layers;

FIG. 9 is an end sectional view of the pipe shown in FIG. 8 along line BB′;

FIG. 10 is an enlarged sectional view of the end sectional view of the pipe as shown in FIG. 9; and

FIG. 11 is a schematic depiction of the manufacturing process for an embodiment of the present invention.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

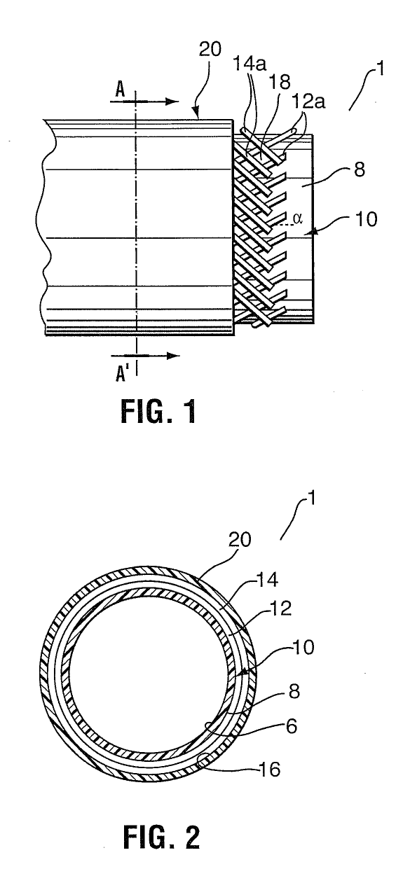

FIGS. 1 and 2 illustrate a flexible pipe 1 reinforced with metal cords and having sufficient strength to transport pressurized fluids, such as oil, gas, water, oil emulsion, etc., yet is still reasonably flexible. The pipe 1 can have an inner layer 10 defined by an inner tubular member, a first reinforcing layer 12, a second reinforcing layer 14, and an outer layer 20. The inner layer 10, being formed as a tubular member, has an inner surface 6 and an outer surface 8. The first reinforcing layer 12 can be adjacent to the inner layer 10 and the second reinforcing layer 14 can lie adjacent to the first reinforcing layer 12. The outer layer 20 may surround the second reinforcing layer 14, the first reinforcing layer 12 and the inner layer 10, with an inner surface 16 of the outer layer 20 facing towards the second reinforcing layer 14. There can be other layers as desired, for example, any pipe may include one or more of: a barrier layer, protection, insulation, a reinforcing layer, etc. inwardly, outwardly and/or between layers 10 and 20.

The inner layer 10 may serve as a lining to contain the fluid passing through the pipe 1 and can be made of any suitable polymer, such as a thermoplastic or an elastomer. Suitable materials, for example, may include one or more of the following nylon, cross-linked polyethylene (PEX), polypropylene, polytetrafluoroethylene (PTFE), higher temperature engineered polymers, high-density polyethylene (HDPE), rubber, nitrides, etc. In many applications, the inner layer 10 can be made substantially impermeable to the fluid passing through the pipe 1 to prevent the fluid from leaking through and outwardly from the inner layer 10 and into the first reinforcing layer 12 and the second reinforcing layer 14. The material making up the inner layer 10 can also selected to be substantially resistant to degradation by the fluid passing through the pipe 1. In some cases, the inner layer 10 may allow some gas diffusion through it but may still be substantially impermeable to liquid. In other cases, the material forming the inner layer 10 can be selected so that it substantially prevents gaseous diffusion through the inner layer 10, in addition to being substantially liquid impermeable. In an aspect, additives such as thermal stabilizers, antioxidants, fillers, process aids, compatibilisers, etc. could be added to the polymer.

The first reinforcing layer 12 and the second reinforcing layer 14 may be formed by metal cords 12a, 14a, respectively, helically wound around underlying layers such as the inner layer 10. The metal cords could be steel including for example, alloy steel, stainless steel, etc. The metal cords making up the first reinforcing layer 12 and the second reinforcing layer 14 can be treated, such as by galvanization with zinc, copper coating, etc., to make them corrosion resistant such as by corrosive permeated gases. The metal cord construction and material properties can be selected such that stress levels are low enough to prevent stress corrosion cracking in the presence of hydrogen sulfide.

In one aspect, the metal cords could each be formed from a single metal wire. In another aspect, the metal cords could be formed of a number of metal wires wound together. Although metal cords of various dimensions could be used, in one aspect, the metal wires making up the metal cords could have a diameter of about 0.2 mm to about 0.5 mm and the overall metal cord could have a diameter of about 0.9 mm to about 2.5 mm. Further, the metal cords may, for example, have a tensile strength between about 275 and about 450 Ksi, or in the more narrow range of about 290 to about 304 Ksi.

The first reinforcing layer 12 can be made up of one or more metal cords that are helically wound around the inner layer 10. The one or more metal cords may be wrapped in a single layer. If the first reinforcing layer 12 contains more than one metal cord, at least some and possibly all of the metal cords in the first reinforcing layer 12 can be wound around the inner layer 10 in a single layer, but some overlapping can be employed, as desired.

The second reinforcing layer 14 can also be made up of one or more metal cords that are helically wound in a second direction around the first reinforcing layer 12. The one or more metal cords may be wrapped in a single layer. If more than one metal cord is used to make up the second reinforcing layer 14, the metal cords of the second reinforcing layer 14 can be wound in a single layer around the first reinforcing layer 12 or they may be overlapped, as desired.

The one or more metal cords of the first reinforcing layer 12 can be wound in a first direction, for example either clockwise or counterclockwise. The one or more metal cords of the second reinforcing layer 14 can be wound in a second direction that can be opposite to the first direction. Therefore, if the metal cord(s) of the first reinforcing layer 12 are wound in a clockwise direction around the inner layer 10, the metal cord(s) of the second reinforcing layer 14 can be wound counterclockwise, and vice versa. Stated another way, the metal cord(s) of the first reinforcing layer 12 can be described as being wound around the inner layer 10 in either a positive helical direction or a negative helical direction, while the metal cord(s) of the second reinforcing layer 14 can be described as being wound around the first reinforcing layer 12 in either a negative helical direction or a positive helical direction, such that, if the metal cord(s) of the first reinforcing layer 12 are defined as being wound in a positive helical direction, the metal cord(s) of the second reinforcing layer 14 can be defined as being wound in a negative helical direction and vice versa.

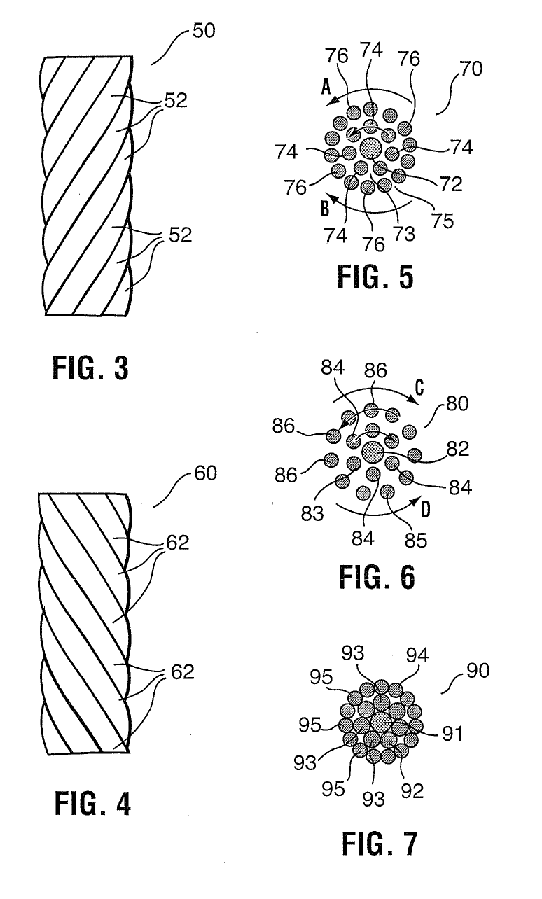

The metal cords of the first reinforcing layer 12 and the second reinforcing layer 14 can each be made up of a number of metal wires that are twisted together to form a metal cord. FIG. 3 illustrates a top view of a first metal cord 50 made up of a number of steel strands 52. The steel wires 52 can be twisted together to form the first metal cord 50 having a Z lay direction. FIG. 4 illustrates a top view of a second metal cord 60 made up of a number of steel wires 62 that can be twisted together to form the second metal cord 60 having an S lay direction. The first metal cord 50 can be formed by twisting a number of steel wires 52 together and the second metal cord 60 can be formed by twisting a number of steel wires 62 together. In one embodiment, the first metal cord 50 and/or the second metal cord 60 can be made using a central guide wire (not shown) and then twisting the steel wires 52 or the steel wires 62 around the central guide wires to make the first metal cord 50 and the second metal cord 60, respectively.

FIGS. 5 and 6 illustrated metal cords 70, 80 in a further aspect. Metal cord 70 can have a central guide wire 72, with a first layer 73 of metal wires 74 wound in a first direction A around the central guide wire 72. A second layer 75 of metal wires 76 can be wound in a second direction B around the first layer 73, and the first direction A is opposite to second direction B. Metal cord 80 can have a central guide wire 82, with a first layer 83 of metal wires 84 wound around the central guide wire 82 in a first direction C. A second layer 85 of metal wires 86 can be wound around the first layer 83 in a second direction D, so that first direction C is opposite to second direction D. In this manner, the metal cords 70, 80 can minimize twist during pressurization and can balance twist, stress and strain during use. These metal cords 70, 80 are defined as having a regular lay and the direction of twist of the metal wires 76, 86 in the second layer 75, 85 can be used to define whether the metal cord 70, 80 has an S lay direction or a Z lay direction, such that metal cords 70, 80 with metal wires 76, 86 in the second layer 75, 85 having an S lay direction can be defined as having an S lay direction and metal cords 70, 80 having metal wires 76, 86 in the second layer 75, 85 having a Z lay direction can be defined as having a Z lay direction.

Referring to FIG. 7, in another aspect, the metal cords could have a lang's lay configuration. The metal cord 90 can have a first layer 92 of metal wires 93 wound around a central guide wire 91 in a first direction and a second layer 94 of metal wires 95 wound around the first layer 92 of metal wires 93 in the same direction. This can be referred to as a lang's lay configuration and can result in better fatigue resistance. Because both the first layer 92 and the second layer 94 are wound in the same direction, the lay direction of the metal cord 90 can be defined by the winding direction of either the first layer 92 or the second layer 94.

Referring again to FIGS. 1 and 2, if more than one metal cord is used, some of the metal cords in the first reinforcing layer 12 can have an S lay direction and some of the metal cords in the first reinforcing layer 12 can have a Z lay direction. In another aspect, all of the metal cords in the first reinforcing layer 12 can have the same lay direction. In the same manner, if more than one metal cord is used in the second reinforcing layer 14, some of the metal cords can have an S lay direction and some of the metal cords can have a Z lay direction. In another aspect, all of the metal cords in the second reinforcing layer 14 could have the same lay direction. In one aspect, the metal cords in the first reinforcing layer 12 can have a lay direction that is the same as the lay direction of the metal cords in the second reinforcing direction 14. For example, all of the metal cords in the first reinforcing layer 12 and the second reinforcing layer 14 can have an S lay direction or a Z lay direction. In another aspect, the lay direction of the metal cords in the first reinforcing layer 12 can be opposite to the lay direction of the metal cords in the second reinforcing layer 14. For example, all of the metal cords in the first reinforcing layer 12 can have a Z lay direction while all of the metal cords in the second reinforcing layer 14 have an S lay direction. Alternatively, all of the metal cords in the first reinforcing layer 12 can have an S lay direction while all of the metal cords in the second reinforcing layer 14 have a Z lay direction. The metal cords could be metal cords 50, 60 shown in FIGS. 3 and 4, metal cords 70 and 80 shown in FIGS. 4 and 5, metal cord 90 shown in FIG. 7, or some other metal cord.

In one aspect, the metal cords in the first reinforcing layer 12 and the second reinforcing layer 14 have a lay direction that is opposite to the direction that they are wound in the pipe 1. For example, if the metal cords in the first reinforcing layer 12 are wound around the inner layer 10 to the left, the metal cords in the first reinforcing layer 12 can have a Z lay direction. The metal cords in the second reinforcing layer 14 can then be wound around the first reinforcing layer 12 to the right and the metal cords in the second reinforcing layer 14 can have an S lay direction. Alternatively, if the metal cords in the first reinforcing layer 12 are wound around the inner layer 10 to the right, the metal cords in the first reinforcing layer 12 can have an S lay while the metal cords in the second reinforcing layer 14 are wound around the first reinforcing layer 12 to the left and they have a Z lay direction.

For the purposes of this invention, a lay configuration can be defined as a regular lay, a lang's lay or any other metal wire twisting to form a cord.

The outer layer 20, in conjunction with the inner layer 10, encloses the first reinforcing layer 12 and the second reinforcing layer 14. The inner layer 10 can act as a liner to prevent fluid leaking or diffusing through the pipe 1 while the first reinforcing layer 12 and the second reinforcing layer 14 are used to withstand the radial force imposed on the pipe by pressurized fluid passing through the pipe. The outer layer 20, therefore, can be selected to primarily protect the first reinforcing layer 12 and the second reinforcing layer 14 from damage (such as by abrasion) and assist in stabilizing and holding the metal cords in the first reinforcing layer 12 and the second reinforcing layer 14 in position. The outer layer 20 can be formed of any suitable flexible material that can protect the first reinforcing layer 12 and second reinforcing layer 14, allowing the material selection of the outer layer 20 to be based on factors such as abrasion resistance, cost, resistance to degradation by environmental effects (i.e. ultraviolet light, weather, etc.), resistance to chemicals that may come in contact with the outer layer 20, etc.

In the pipe 1, the inner layer 10 is not required to withstand all of the internal pressure imposed by pressurized fluid passing through the pipe 1. Rather, the inner layer 10 can resist diffusion of the fluid through the wall of inner layer 10 while the first reinforcing layer 12 and second reinforcing layer 14 act in combination to contain the internal pressure imposed on the pipe 1 by pressurized fluid passing through it.

The first reinforcing layer 12 and the second reinforcing layer 14 can act to counteract the majority, if not all, of the radial and axial loads imposed on the pipe 1 including the internal pressure of the pressurized fluid passing through the pipe and tensile loading of the pipe. While the inner layer 10 does not need to be strong enough to withstand the pressure imposed on the pipe 1 by the pressurized fluid passing through the pipe 1, the inner layer 10 is typically made sufficiently strong to withstand the loads placed on it by the winding process where metal cords are wound around the inner layer 10 to form the first reinforcing layer 12 and the second reinforcing layer 14, as well as loads placed on it by the application of the outer layer 20, installation of the pipe 1, handling of the pipe 1, etc.

The reinforcing layers support the majority, if not all, of the axial and radial loads imposed on the pipe 1. A primary load is in the tensile direction of the metal cords in the first reinforcing layer 12 and the second reinforcing layer 14 because typically little side load is induced under normal operating conditions of the pipe 1. The angle of the windings of the metal cords in the first reinforcing layer 12 and the second reinforcing layer 14 are selected to compromise between the various loads and conditions to which the product will be exposed during processing and during the use of the pipe 1, including durability and pressure containment, while providing desired flexibility. Winding angles a, relative to the longitudinal axis of the pipe, of between 8° and 86° can be used. Generally, a greater winding angle allows the pipe 1 to withstand greater radial loading, such as from internal pressure caused by the pressurized fluid, while a smaller angle of winding will allow the pipe 1 to withstand more axial loading of the pipe 1. In many cases, a pipe 1 according to the presently illustrated embodiment is used to contain pressurized fluid with the prominent condition being internal pressure containment, therefore the pipe 1 will have winding angles chosen to withstand more force in the radial tensile direction. Other factors such as installation pull force (axial loading) and loads from spooling and unspooling for transport and installation in the field can also be taken into account. In one aspect, winding angles of between 40° and 70° are used, with a narrower range, in some embodiments, of winding angles being between 50° and 60° being suitable.

As will be appreciated the metal cords are wrapped to form reinforcing layers. The metal cords can be laid directly alongside each other or with spaces between adjacent wraps of the cords. Wrapping of the cords forms what may be termed valleys 18 in the surface contour of the reinforcing layer, the valleys defined between adjacent wraps of the cords. For example, valleys may be gaps, spaces or voids if the metal cords are not laid directly beside each other and, since the cords are generally rounded in cross section, valleys may even be formed if the metal cords are laid directly alongside each other where the surface contour defined by the cords dips down at the interface between two adjacent cords. Any valleys between the metal cords in the first reinforcing layer and the metal cords in the second reinforcing layer 14 may be chosen to be small enough to prevent the inner layer 10 from being forced between the metal cords and rupturing when high pressure fluid is transported through the pipe 1. For example, the spacing between the metal cords may be up to 250% or in some examples, within a range of 50% to 200% of the diameter of the metal cords in that layer. By having sufficiently small spacing between the metal cords the majority of the force imposed on the pipe 1 by the pressurized fluid can be transferred and contained by the first reinforcing layer 12 and the second reinforcing layer 14. The stiffness of material used for the inner layer 10 is a factor in the size of the spacings of the metal cords in the first reinforcing layer 12 and the second reinforcing layer 14 because a stiffer inner layer 10 may better distribute forces imposed by internal pressure across spaces between the metal cords.

In one embodiment, either the first, second or both of the reinforcing layers may comprise more than one layer of metal cords, for example, one or more metal cords may be initially wound around the inner layer, or first reinforcing layer as the case may be, forming a first layer and an overlapping layer of one or more metal cords may be wound about the first layer thereby forming a reinforcing layer with more than one layer of reinforcements.

In a further possible embodiment, the outer layer 20 can penetrate into and possibly substantially fill the valleys between cords of the second reinforcing layer, which may at least partially mechanically restrict movement of the cords 14a in the second reinforcing layer to assist in maintaining substantially constant valley dimensions and winding angles of the second reinforcing layer.

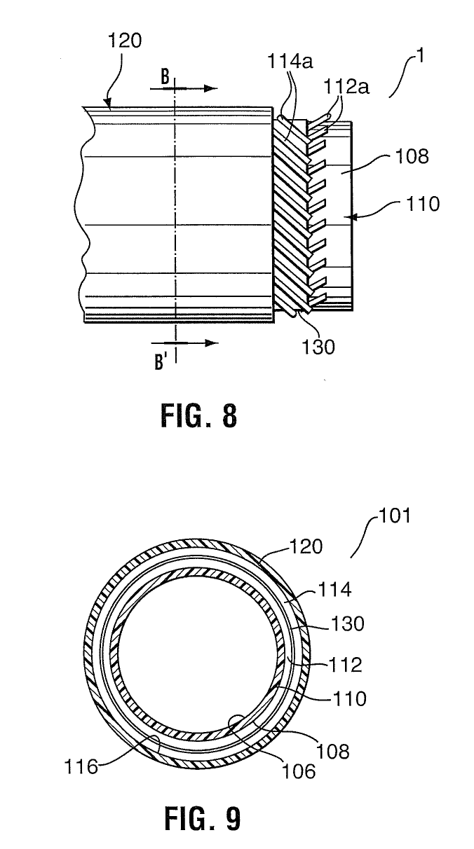

FIGS. 8 and 9 illustrate a further aspect of a pipe 101 that is reinforced with metal cords and has sufficient strength to transport pressurized fluid yet still remains relatively flexible. The pipe 101 can have an inner layer 110, a first reinforcing layer 112, a barrier layer 130, a second reinforcing layer 114 and an outer layer 120. The inner layer 110, the first reinforcing layer 112, the second reinforcing layer 114 and the outer layer 120 can be similar to the inner layer 10, the first reinforcing layer 12, the second reinforcing layer 14 and the outer layer 20 of pipe 1 shown in FIGS. 1 and 2.

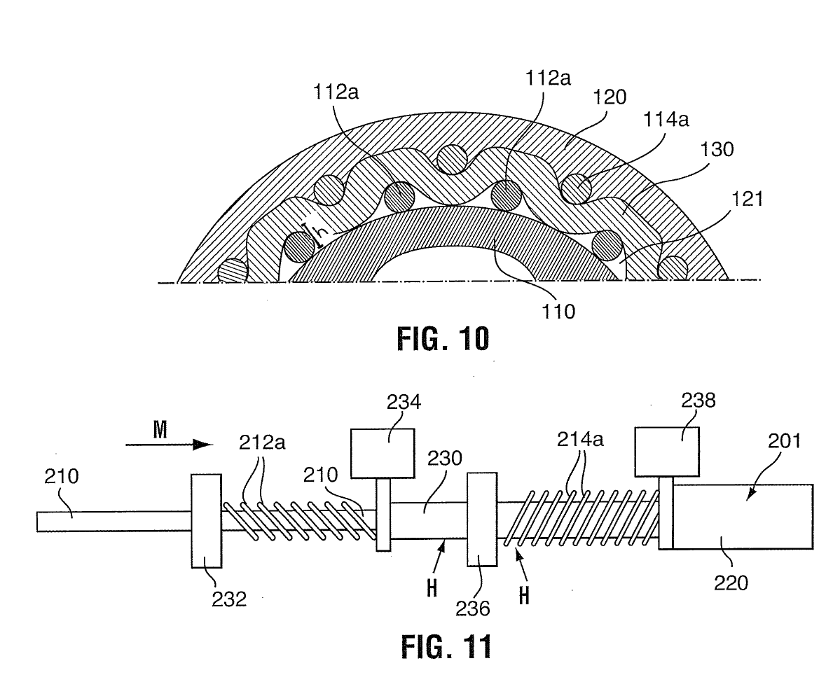

As depicted in FIG. 10, the barrier layer 130 can be provided between the first reinforcing layer 112 and the second reinforcing layer 114 and can penetrate into each reinforcing layer. Barrier layer 130 can be used to secure the cords. For example, the barrier layer may secure the cords by maintaining a substantially uniform cord placement, cord spacing and winding angles for the metal cords of the reinforcing layer and prevent fretting. For example, fretting may cause corrosion between the first reinforcing layer 112 and the second reinforcing layer 114. The barrier layer penetrates between the cords 112a, into the valleys of the first layer. The height (depicted as h in FIG. 10) of the first reinforcement layer 112 above the inner layer 110, which height is at least about the diameter of one cord and possibly more if the cords are applied in an overlapping fashion, may be partially to fully enclosed by the barrier layer 130, for example, between 120 to 100% enclosed. The barrier layer may penetrate into the valleys of the second reinforcement layer 114, thereby enclosing the second reinforcing layer, by the barrier layer 130, the outer layer 120 or a combination of the barrier layer 130 and the outer layer 120. The height of the second reinforcement layer 114, which is approximately at least the diameter of one metal cord and possibly the height of one or more tiers, may also be partially to fully enclosed, for example between 20 to 100% enclosed. In one embodiment, the second reinforcing layer is fully enclosed by the barrier layer (about 25 to 75%) and the outer layer (25 to 75%). The barrier layer 130 may be bonded to some degree to the first reinforcing layer 112 and/or the second reinforcing layer 114. Some degree of bonding can be provided between the barrier layer 130 and the outer layer 120 or the barrier layer 130, the outer layer 120 and the inner layer 110. Further, some degree of bonding may be established between the barrier layer 130 and other thermoplastic layers to improve stiffness of the pipe 110, cord retention at fittings, cord load sharing, use of electrofusion or mechanical crimp fittings, etc.

In one embodiment, there may be one or more air pockets 121 between the outer surface of the inner layer, the at least one metal cord of the first reinforcing layer and the barrier layer (FIG. 10). The air pockets may be continuous along the longitudinal axis of the inner layer and may provide a cavity to trap any gases that diffuse across the inner layer. Trapped gases may further move axially along the air pockets ultimately to be released at an end of the pipe.

### Method of Making Pipe

With reference to FIG. 11, a pipe 201 can be formed by wrapping one or more metal cords around an inner layer 210. The inner layer 210 could be formed in an earlier process and used as a starting point for the process of making the pipe by passing the earlier formed inner layer 210 through the process so that the other layers can be applied to it. Alternatively, the inner layer 210 could be formed during the process, such as by extrusion, etc. The pipe can be formed using a continuous production approach allowing the finished pipe to be wound around a spool and cut to a desired length.

The first reinforcing layer including cords 212a can be applied to the inner layer 210 by winding one or usually more metal cords around the outer surface of the inner layer 210 in a first direction (clockwise or counter clockwise around the inner layer 210) and at a first angle. In one aspect, these metal cords are wound around the inner layer 210 when it is in the solid state and therefore do not integrate with the inner layer. In such an embodiment, the metal cords overlie and bear against the inner layer substantially without sinking into the inner layer.

In another possible embodiment, the metal cords of the first reinforcing layer may be wound over the inner layer when the inner layer is in a moldable condition, allowing the material of the inner layer to at least partially mold around and adhere to at least some degree to at least some of the metal cords of the first reinforcing layer, as the cords are applied thereon. For example, the inner layer may be extruded and used directly thereafter or softened as by heating and the metal cords of the first reinforcing layer can be wound around the inner layer while it is in a moldable condition (i.e. molten, semi-molten, uncured or semi-uncured) so that at least the outer surface of the inner layer has not yet solidified. In this manner, the metal cords 212a of the first reinforcing layer can be made to sink to some degree into the outer surface of the inner layer 210 causing at least some of the metal cords in the first reinforcing layer to at least partially adhere to or sink in the outer surface of the inner layer 210 when the inner layer has solidified and/or cured. In an aspect, all of the metal cords in the first reinforcing layer can have the same lay direction, with all of the metal cords in the first reinforcing layer having either an S lay direction or a Z lay direction.

With the metal cords of the first reinforcing layer wound around the outer surface of the inner layer 210, the second reinforcing layer can be formed by winding more metal cords 214a over the first reinforcing layer in an opposite direction to the metal cords 212a of the first reinforcing layer. For example, if the metal cords in the first reinforcing layer are wound in the clockwise direction relative to the inner layer 210 then the metal cords of the second reinforcing layer are wound in the counterclockwise direction and vice versa. The metal cords making up the second reinforcing layer can all be wound at the same angle, if desired.

In an aspect, the metal cords of the first reinforcing layer and the second reinforcing layer can have opposite lay directions. For example, if the metal cords in the first reinforcing layer all have an S lay direction, the metal cords in the second reinforcing layer might all have a Z lay direction. Alternatively, if the metal cords in the first reinforcing layer all have a Z lay direction, all of the metal cords in the second reinforcing layer might have an S lay direction.

In a further aspect, if the metal cords of a reinforcing layer are made up of wires, the wires will have a lay configuration that is a regular lay, lang's lay or any other combination of metal wire directional twisting.

The application of the second reinforcing layer can take into consideration the different desired characteristics as outlined above with reference to the first reinforcing layer. In one aspect, the first reinforcing layer and the second reinforcing layer are applied such that they have substantially the same load carrying capabilities with the first reinforcing layer and the second reinforcing layer having substantially equal numbers of metal cords but applied with substantially opposite winding directions.

The winding of metal cords can be achieved with the use of winders that wrap the cords in a helical fashion around the pipe surface about which they are being applied, as the pipe is being advanced as in arrow M. The metal cords can be wound tensively, for example, at a substantially continuous tension, determined to give a desired effect. For example, to cause the metal cords to sink into the outer surface of the inner layer 210, if that is desired.

The inner layer 210 can be selected to support the loads induced on it by the winding of the metal cords 212a, 214a of the first reinforcing layer and the second reinforcing layer, as well as the application of the outer layer 220. The tension of the metal cords being wound around the inner layer 210 to form the first reinforcing layer and the second reinforcing layer can be controlled to avoid the collapse of the inner layer 210 during production of the pipe 201. However, in some cases it may be useful to support the inner layer by use of one or more internal supports, such as a mandrel, a roller, internal pressure, etc. during the forming process for the pipe. It may also be useful to employ these internal supports to urge the inner layer 210 into having a generally circular cross-section.

A barrier layer 230 can then be applied over the first reinforcing layer, such as by extrusion, spraying, dipping, tape winding, shrink wrapping, braiding, etc. The barrier layer 230 can be applied over the first reinforcing layer so that it is in a moldable condition. In one possible embodiment, the barrier layer 230 is applied in a moldable condition (i.e. soft, uncured, molten, flowable, etc.), so that the barrier layer 230 at least partially molds around at least some of the metal cords 212a causing the metal cords in the first reinforcing layer to adhere to some degree to the inside surface of the barrier layer 230. The pipe could also be heated after application of the barrier layer to soften that layer and allow it to at least partially mold around cords 212a and is ready to accept the cords 214a. The penetration of the barrier layer into the valleys of the first and/or second reinforcing layers maintains the placement of the reinforcements.

The outer layer 220 can then be applied over the second reinforcing layer, such as by extrusion, spraying, dipping, tape winding, shrink wrapping, braiding, etc. The outer layer 220 can be applied over the second reinforcing layer so that it is in a moldable condition. In one possible embodiment, the outer layer is applied in a moldable condition (i.e. soft, uncured, molten, flowable, etc.), so that the outer layer 220 at least partially molds around at least some of the metal cords 214a in the second reinforcing layer causing the metal cords in the second reinforcing layer to adhere to some degree to the inside surface of the outer layer 220. The pipe could also be heated after it is constructed to soften the outer layer 220 and allow it to at least partially mold around the second reinforcing layer. The molding of the outer layer 220 around the second reinforcing layer may also be done to at least partially mechanically constrict the second reinforcing layer.

As shown in FIG. 11, first reinforcing layer may be wound around the inner layer by a first winding mechanism 232, the details and options of which will be appreciated by those skilled in the art. The barrier layer 230 can be formed over the first reinforcing layer by a first forming mechanism 234, such as by spraying, dipping, extrusion, helically wrapped strips, etc., before the second reinforcing layer is applied over top of the barrier layer 230 by a second winding mechanism 236 appreciated by those skilled in the art. A second forming mechanism 238 can form the outer layer over the second reinforcing layer, such as by extrusion, helically wrapped strips, etc. in such a manner, as appreciated by those skilled in the art, to penetrate into the valleys of the second reinforcing layer so that the cords of the second reinforcing layer are partially or completely enclosed.

To facilitate penetration of the cords to the inner, barrier and outer layers, heat may be applied to the pipe or the materials added thereto during the process. For example, heat may be applied to the partially formed pipe or the components (i.e. cords), by techniques and ranges appreciated by those skilled in the art depending on the materials of the pipe, before and/or after the application of first and/or the second reinforcing layer. In one embodiment, for example, heat (H) may be applied, by techniques and ranges appreciated by those skilled in the art, to the barrier layer 230 prior to the second winding mechanism 236. This application of heat softens the barrier layer such that it tends to penetrate in to the valleys of the first reinforcing layer and, as the second reinforcing layer is wound over the barrier layer, it tends to sink into the heated barrier layer material. Heat (H) may also or alternately be applied following the second winding mechanism to facilitate the incorporation of the second winding layer into the barrier layer, for example the barrier layer filling in the valleys of the second reinforcing layer and to introduce thermal energy to the cords such that the outer layer tends to soften and mold about the cords as the outer layer is being applied.

The heat required for this process may be selected to be at or close to the melting point of the polymeric material used for the applied layer. For example, heaters at points H may bring the temperature of the barrier layer and/or cords within 100° C. of the melting temperature of the polymer used in the layer, be it the barrier layer or the outer layer.

### Performance

For many hydrocarbon handling operations, a pipe may be acceptable that has a 3000 psi burst pressure and a minimum bend radius of at least 15 times the outer diameter of the pipe. Other performance properties may be desired for other applications.

As an example, a high temperature flexible pipe was produced in accordance with Table I, provided below.

TABLE I
Production
Inner Tubular Lining

| Material | High density polyethylene | |
|---|---|---|
| Outer Diameter | In | 3.375 |
| Inner Diameter | In | 2.995 |

First Reinforcing Layer

| Material | Steel | |
|---|---|---|
| Cord type | 1 + 6 + 12 S regular lay | |
| Wrap angle | deg. | 54° in S-direction |
| Number of cords per wrap | | 64 |
| Filament diameter | mm | 0.3 |
| Cord diameter | mm | 1.5 |

Barrier Layer

| Material | High density polyethylene | |
|---|---|---|
| Outer Diameter | in | 3.533 |
| Thickness | in | 0.020 |

Second Reinforcing Layer

| Material | Steel | |
|---|---|---|
| Cord type | 1 + 6 + 12 S regular lay | |
| Wrap angle | deg. | 56° in Z-direction |
| Number of cords per wrap | | 64 |
| Filament diameter | mm | 0.3 |
| Cord diameter | mm | 1.5 |

Outer Layer

| Material | High density polyethylene | |
|---|---|---|
| Outer Diameter | In | 3.900 |
| Inner Diameter | In | 3.651 |

The tested performance for the pipe of Table I is shown in Table II.

TABLE II
Performance

| | | |
|---|---|---|
| Design operating pressure | Psi | 1500 |
| Short term burst pressure | Psi | 4892 |
| Amount of twist at 1500 psi | degrees/meter (°/m) | 1.0 |

| | |
|---|---|
| Number of cycles to failure (0-1500) | >187,000 |

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

We claim:

1. A flexible pipe comprising:
(a) an inner tubular layer with an inner surface and an outer surface, the inner surface forming a central bore for conveying a fluid therewithin;
(b) a first reinforcing layer of at least one first metal cord wound around the outer surface in a first helical direction to support axial and radial loads on the inner tubular layer, the first reinforcing layer including valleys defined between adjacent wraps of the at least one first metal cord;
(c) a second reinforcing layer of at least one second metal cord wound outwardly of the first reinforcing layer to support axial and radial loads on the inner tubular layer and the first reinforcing layer, the second reinforcing layer including valleys defined between adjacent wraps of the at least one second metal cord;
(d) an outer layer provided on the second reinforcing layer to protect the first and second reinforcing layers; and
(e) a barrier layer between the first and second reinforcing layers, the barrier layer penetrating into the valleys of the first and second reinforcing layers.

2. The flexible pipe of claim 1, wherein the first helical direction is opposite to the second helical direction.

3. The flexible pipe of claim 1, wherein the first helical direction and second helical direction are the same direction.

4. The flexible pipe of claim 1, wherein the at least one first metal cord includes a plurality of metal wires twisted around each other in a first direction and the at least one second metal cord further comprises a plurality of metal wires twisted around each other in a second direction.

5. The flexible pipe of claim 4, wherein the first direction is opposite to the second direction.

6. The flexible pipe of claim 4, wherein the first direction and the second direction are the same direction.

7. The flexible pipe of claim 4, the at least one first metal cord includes a first layer of metal wires and second layer of metal wires twisted around a first central guide wire in a lay configuration and the at least one second metal cord further comprises a first layer of metal wires and second layer of metal wires twisted around a second central guide wire in a lay configuration.

8. The flexible pipe of claim 1, wherein the barrier layer is bonded to the outer layer.

9. The flexible pipe of claim 1, wherein the barrier layer is bonded to the inner layer.

10. A method for making pipe, the method comprising:
(a) tensively wrapping at least one first metal cord in a first direction around an inner tubular member at a first angle, the at least one first metal cord forming a first reinforcing layer and having valleys defined between adjacent wraps of the at least one first metal cord;
(b) forming a barrier layer over the first reinforcing layer, the barrier layer penetrating into the valleys of the first reinforcing layer;
(c) tensively wrapping at least one second metal cord in a second direction around an inner tubular member at a second angle, the at least one second metal cord forming a second reinforcing layer and having valleys defined between adjacent wraps of the at least one second metal cord, the barrier layer penetrating into the valleys of the second reinforcing layer; and
(d) applying an outer layer over the second reinforcing layer.

11. The method of claim 10, wherein the barrier layer is softened to permit penetration into the valleys.

12. The method of claim 10, further comprising heating the barrier layer before tensively wrapping the at least one second metal cord.

13. The method of claim 10, further comprising applying heat to second reinforcing layer and any of the barrier layer exposed below the second reinforcing layer after tensively wrapping the at least one second metal cord.

14. The method of claim 10, wherein the outer layer is bonded to the barrier layer to fully encase the at least one second metal cord.

15. The method of claim 10, further comprising after forming and before tensively wrapping the at least one second metal cord: applying heat to the barrier layer; and after tensively wrapping the at least one second metal cord, applying heat to the second reinforcing layer and any of the barrier layer exposed below the second reinforcing layer.

16. The method of claim 10, wherein the at least one first metal cord comprises a first plurality of metal wires twisted around each other in a first wire direction and the at least one second metal cord comprises a second plurality of metal wires twisted around each other in a second wire direction.

17. The method of claim 16, wherein the first wire direction is opposite the second wire direction.

18. The method of claim 16, wherein the first wire direction and the second wire direction are the same direction.

19. The method of claim 10, wherein the first direction is opposite to the second direction.
